(19) United States
(12) Patent Application Publication
(10) Pub. No.: US 2026/0080105 A1
(43) Pub. Date: Mar. 19, 2026

(54) Storage Device, Operating Method of Storage Device, And Computing Device

(71) Applicant: Samsung Electronics Co., Ltd., Suwon-si (KR)

(72) Inventors: Sewon Kim, Suwon-si (KR); Mingon Shin, Suwon-si (KR); Yongsuk Lee, Suwon-si (KR); Younsung Chu, Suwon-si (KR)

(21) Appl. No.: 19/312,584

(22) Filed: Aug. 28, 2025

(30) Foreign Application Priority Data
Sep. 19, 2024 (KR) 10-2024-0126790

(51) Int. Cl. G06F 21/72; G06F 21/60; G06F 21/78

(52) U.S. Cl. CPC G06F 21/72; G06F 21/602; G06F 21/78

(57) ABSTRACT

A storage device includes a plurality of cores respectively including a plurality of memory protection units (MPUs) and a trust core configured to in response to receiving a measurement command from a host device, acquire MPU information of each of the plurality of MPUs, generate a hash result of the plurality of cores based on the MPU information of each of the plurality of MPUs, and transmit the hash result of the plurality of cores to the host device.

### CROSS-REFERENCE TO RELATED APPLICATION

This application is based on and claims priority under 35 U.S.C. § 119 to Korean Patent Application No. 10-2024-0126790, filed on Sep. 19, 2024, in the Korean Intellectual Property Office, the disclosure of which is incorporated by reference herein in its entirety.

### BACKGROUND

A storage device may store various types of data for an operation of a computing device. For example, the storage device may store code data including code of a program to be executed by a computing device.

To hack the storage device, malicious code may be injected into the storage device such that the malicious code is executed by a computing device. To prevent such hacking, an attestation operation may be performed. However, such an attestation operation is limited to detecting whether data stored in a read only (RO) area in a storage device, in which code data is generally stored, is falsified.

### SUMMARY

The present disclosure provides a storage device for performing an attestation operation on code data stored in the whole area in the storage device.

According to an aspect of the present disclosure, a storage device is provided including a plurality of cores respectively including a plurality of memory protection units (MPUs) and a trust core configured to perform an attestation operation on the plurality of MPUs, wherein the trust core is further configured to, when a measurement command is received from a host device, acquire MPU information of each of the plurality of MPUs, generate a hash result of each of the plurality of cores, based on the MPU information of each of the plurality of MPUs, and transmit the hash result to the host device.

According to another aspect of the present disclosure, an operating method of a storage device includes a plurality of cores respectively including a plurality of MPUs and a trust core configured to perform an attestation operation on the plurality of MPUs, the method including receiving, by an attestation handler included in the trust core, a measurement command from a host device, transmitting, by the attestation handler, a measurement request to a measurement information parser included in the trust core, acquiring, by the measurement information parser, MPU information of each of the plurality of MPUs, generating, by a hash generating circuit included in the trust core, a hash result of each of the plurality of cores, based on the MPU information of each of the plurality of MPUs, transmitting, by the hash generating circuit, the hash result of each of the plurality of cores to the attestation handler via the measurement information parser, and transmitting, by the attestation handler, the hash result to the host device.

According to another aspect of the present disclosure, a computing device includes a host device configured to transmit a measurement command and a storage device configured to, when the measurement command is received from the host device, perform an attestation operation and transmit measurement information to the host device, wherein the storage device includes a plurality of cores respectively including a plurality of MPUs and a trust core configured to perform the attestation operation on the plurality of MPUs, wherein the trust core is further configured to, when the measurement command is received, acquire MPU information of each of the plurality of MPUs, generate a hash result of each of the plurality of cores, based on the MPU information of each of the plurality of MPUs, generate the measurement information based on the hash result, and transmit the measurement information to the host device.

### BRIEF DESCRIPTION OF THE DRAWINGS

Implementations of the present disclosure will be more clearly understood from the following detailed description taken in conjunction with the accompanying drawings in which:

FIG. 1 is a block diagram illustrating a computing device according to an implementation;

FIG. 2 is a block diagram illustrating a detailed structure of a storage device according to an implementation;

FIG. 3 illustrates memory protection unit (MPU) information used by a storage device, according to an implementation;

FIG. 4 illustrates hash results generated by a storage device, according to an implementation;

FIG. 5 is a flowchart illustrating an operating method of a storage device, according to an implementation;

FIG. 6 is a flowchart illustrating a method of generating hash results in a storage device, according to an implementation;

FIG. 7 is a flowchart illustrating a method of transmitting measurement information from a storage device to a host device, according to an implementation;

FIG. 8 is a flowchart illustrating a method, performed by a host device included in a computing device, of determining whether falsification has occurred in a storage device, according to an implementation;

FIG. 9 is a signaling diagram illustrating an operating method of a computing device, according to an implementation; and

FIG. 10 is a signaling diagram illustrating an operating method of components included in a trust core of a storage device, according to an implementation.

### DETAILED DESCRIPTION

Hereinafter, implementations of the present disclosure are described in detail with reference to the accompanying drawings.

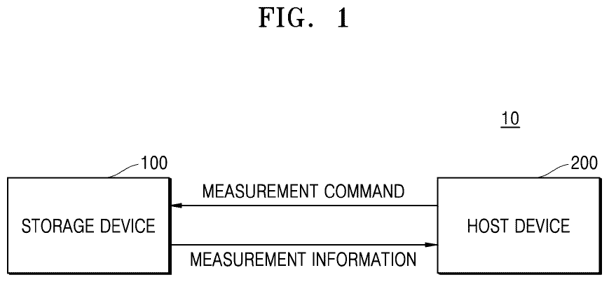

FIG. 1 is a block diagram illustrating a computing device 10 according to an implementation.

Referring to FIG. 1, the computing device 10 according to an implementation may include a storage device 100 and a host device 200.

The computing device 10 may be implemented by, for example, a personal computer (PC), a data server, a network-attached storage (NAS), an Internet of Things (IoT) device, or a portable electronic device. The portable electronic device may be a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, or the like.

The storage device 100 may include storage media storing data in response to a command from the host device 200. For example, the storage device 100 may include at least one of a solid state drive (SSD), an embedded memory, and a detachable external memory. When the storage device 100 is an SSD, the storage device 100 may conform to a non-volatile memory express (NVMe) standard.

When the storage device 100 is an embedded memory or an external memory, the storage device 100 may conform to a universal flash storage (UFS) or embedded multi-media card (eMMC) standard. Each of the host device 200 and the storage device 100 may generate a packet according to a standard protocol employed therein and transmit the packet therebetween. In an implementation, the storage device 100 may be an embedded memory embedded in the computing device 10, and for example, the storage device 100 may be an eMMC or embedded UFS memory device. In an implementation, the storage device 100 may be an external memory detachably attached to the computing device 10, and for example, the storage device 100 may be a UFS memory card, a compact flash (CF) card, a secure digital (SD) card, a micro-SD card, a mini-SD card, an extreme digital (xD) card, or a memory stick.

The host device 200 may communicate with the storage device 100 via various interfaces and transmit a request, such as a read request, a program request, or an erase request, to the storage device 100. In an implementation, the host device 200 may be implemented by an application processor (AP) or a system-on-a-chip (SoC).

In an implementation, the host device 200 may transmit a measurement command to the storage device 100. The measurement command may be a command for the storage device 100 to transmit measurement information generated based on code data to the host device 200 in order to determine whether the code data stored in the storage device 100 is falsified.

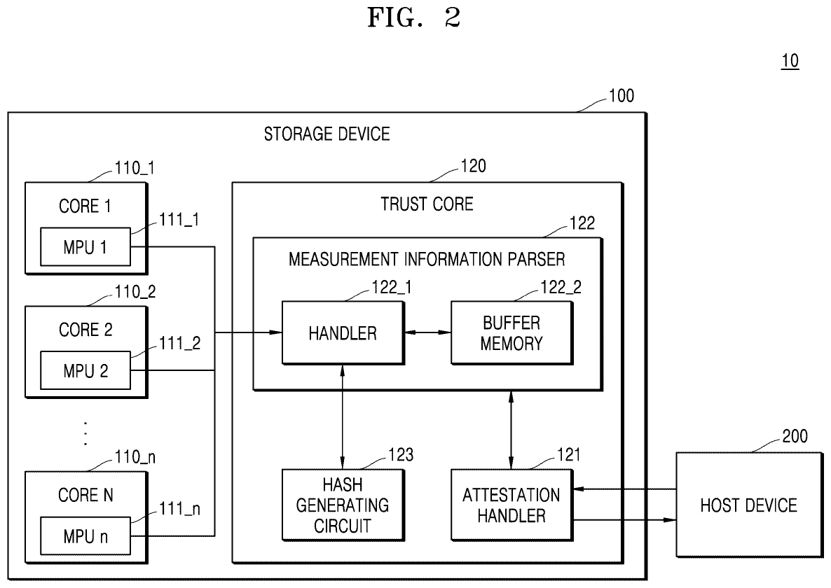

In an implementation, the storage device 100 may perform an attestation operation on first to n-th MPUs 111_1 to 111_n (see FIG. 2) upon receiving the measurement command from the host device 200. The attestation operation may be a series of operations of generating, by the storage device 100, the measurement information based on the code data such that the host device 200 may determine whether the code data stored in the storage device 100 is falsified. The storage device 100 may transmit, to the host device 200, the measurement information generated by performing the attestation operation on the first to n-th MPUs 111_1 to 111_n (see FIG. 2).

A detailed structure of the storage device 100 and a particular method, performed by the storage device 100, of generating measurement information by performing an attestation operation on the first to n-th MPUs 111_1 to 111_n (see FIG. 2) upon receiving a measurement command may be described in more detail with reference to FIGS. 2 to 10.

FIG. 2 is a block diagram illustrating a detailed structure of the storage device 100 according to an implementation.

Referring to FIG. 2, the storage device 100 according to the present implementation may include a plurality of cores, e.g., first to n-th cores 110_1 to 110_n (n is a natural number greater than or equal to 2), and a trust core 120.

The plurality of cores, e.g., the first to n-th cores 110_1 to 110_n, may include a plurality of memory protection units (MPUs), e.g., the first to n-th MPUs 111_1 to 111_n, respectively. In the implementation of FIG. 2, a k-th core 110_k (k is a natural number of 1 to n inclusive) may include a k-th MPU 111_k.

Each of the first to n-th MPUs 111_1 to 111_n may set memory areas in the storage device 100 to respectively meet the use purposes of the memory areas such that abnormal access to the memory areas is restricted. In an implementation, the first to n-th MPUs 111_1 to 111_n may store a plurality of MPU information, e.g., first MPU information to n-th MPU information, respectively. For example, the k-th MPU 111_k may store k-th MPU information.

MPU information may be information on memory areas in the storage device 100, which are managed by a corresponding MPU. In an implementation, MPU information may include the addresses of memory areas managed by a corresponding MPU and whether data stored in corresponding addresses is executable. In general, such MPU information may not be accessible by the other cores. For example, the second to n-th cores 110_2 to 110_n may not access the first MPU information of the first MPU 111_1 included in the first core 110_1.

However, in an implementation, the trust core 120 may access the first MPU information to the n-th MPU information of the first to n-th MPUs 111_1 to 111_n included in the first to n-th cores 110_1 to 110_n, respectively. Accordingly, the trust core 120 may perform an attestation operation on the first to n-th MPUs 111_1 to 111_n as described below.

The trust core 120 may perform an attestation operation on the first to n-th MPUs 111_1 to 111_n. The trust core 120 may generate hash results by performing an attestation operation on the first to n-th MPUs 111_1 to 111_n and transmit the hash results to the host device 200.

In more detail, when a measurement command is received from the host device 200, the trust core 120 may acquire MPU information of each of the first to n-th MPUs 111_1 to 111_n. For example, the trust core 120 may acquire the first MPU information to the n-th MPU information. The trust core 120 may generate a hash result of each of the first to n-th cores 110_1 to 110_n, based on MPU information of each of the first to n-th MPUs 111_1 to 111_n. For example, the trust core 120 may generate a hash result of the k-th core 110_k, based on the k-th MPU information. The trust core 120 may transmit a hash result of each of the first to n-th MPUs 111_1 to 111_n to the host device 200.

The trust core 120 may include an attestation handler 121, a measurement information parser 122, and a hash generating circuit 123.

When a measurement command is received from the host device 200, the attestation handler 121 may transmit the measurement command to the measurement information parser 122 and transmit hash results generated by the measurement information parser 122 to the host device 200.

In an implementation, when the measurement command is received from the host device 200, the attestation handler 121 may generate a measurement request. The measurement request may be a request for the measurement information parser 122 to perform an attestation operation on the first to n-th MPUs 111_1 to 111_n and transmit hash results generated as a result of performing the attestation operation.

When the measurement request is received from the attestation handler 121, the measurement information parser 122 may acquire MPU information of each of the first to n-th MPUs 111_1 to 111_n. For example, the measurement information parser 122 may acquire the first MPU information to the n-th MPU information.

The measurement information parser 122 may include a handler 122_1 and a buffer memory 122_2.

In an implementation, the handler 122_1 may read MPU information from each of the first to n-th MPUs 111_1 to 111_n.

For example, the handler 122_1 may be connected to the first to n-th MPUs 111_1 to 111_n via a bus and read MPU information in real-time from each of the first to n-th MPUs 111_1 to 111_n via the bus.

As another example, the handler 122_1 may transmit an MPU information request to each of the first to n-th MPUs 111_1 to 111_n and receive MPU information from each of the first to n-th MPUs 111_1 to 111_n.

In an implementation, the handler 122_1 may generate executable area information of each of the first to n-th MPUs 111_1 to 111_n, based on MPU information of each of the first to n-th MPUs 111_1 to 111_n. For example, the handler 122_1 may generate k-th executable area information based on the k-th MPU information of the k-th MPU 111_k.

Executable area information may be information on areas, in which code data is stored, and which are set to be executable, in memory areas managed by each of the first to n-th MPUs 111_1 to 111_n. In an implementation, executable area information may include addresses, in which data set to be executable is stored, among the addresses of the memory areas managed by each of the first to n-th MPUs 111_1 to 111_n.

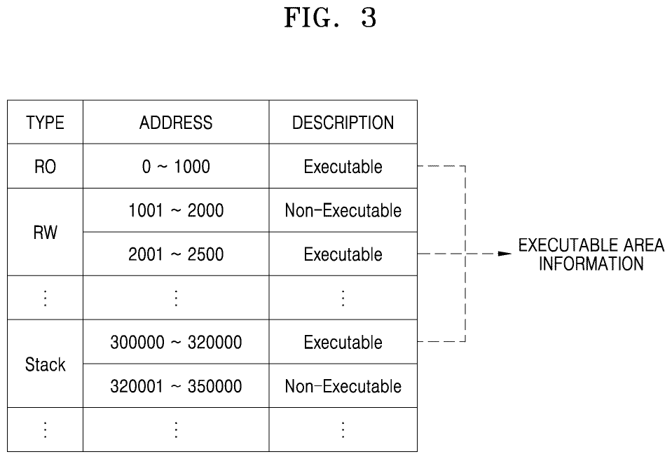

One example of MPU information and executable area information is described with reference to FIG. 3.

FIG. 3 illustrates MPU information used by a storage device, according to an implementation.

Referring to FIG. 3, a table illustrating MPU information and executable area information generated based on the MPU information are shown.

The table of FIG. 3 illustrates MPU information. The MPU information may include the types (type column) of memory areas managed by an MPU, the addresses (address column) of a memory area of a corresponding type, and whether data stored in corresponding addresses is executable (description column).

First, when the type of a memory area is read only (RO), the memory area may be a readable but unwritable area in which code data may be stored. In the implementation of FIG. 3, addresses 0 to 1000 having RO as the type of a memory area may be set to be executable.

Next, when the type of a memory area is read write (RW), the memory area is both readable and writable and is generally an area in which data, which shall not be falsified, such as code data, is not stored and other types of data may be stored. However, due to a reason, such as a developer's carelessness or a malicious user's code injection, code data may be stored in the addresses of a memory area of which the type is RW, and the addresses may be set to be executable. In the implementation of FIG. 3, addresses 1001 to 2000 having RW as the type of a memory area may be set to be non-executable, and addresses 2001 to 2500 having RW as the type of a memory area may be set to be executable. In this case, because the addresses 2001 to 2500 having RW as the type of a memory area is set to be executable, code data may be stored in the memory area.

Finally, when the type of a memory area is stack, the memory area is an area in which data to be used by a program is temporarily stored, and in general, data, which shall not be falsified, such as code data, may not be stored in the memory area. However, when a malicious user's code injection occurs, code data may be stored in addresses having stack as the type of a memory area. In the implementation of FIG. 3, addresses 300000 to 320000 having stack as the type of a memory area may be set to be executable, and addresses 320001 to 350000 having stack as the type of a memory area may be set to be non-executable. In this case, because the addresses 300000 to 320000 having stack as the type of a memory area are set to be executable, code data may be stored in the memory area.

The handler 122_1 may generate executable area information based on MPU information. In the implementation of FIG. 3, the handler 122_1 may generate executable area information indicating that data set to be executable is stored in the addresses 0 to 1000, 2001 to 2500, and 300000 to 320000, based on whether data stored in corresponding addresses is executable (the description column) in the MPU information illustrated in the table of FIG. 3.

Referring back to FIG. 2, in an implementation, the buffer memory 122_2 may store a hash result of each of the first to n-th cores 110_1 to 110_n, which is received from the hash generating circuit 123. The buffer memory 122_2 may temporarily store hash results generated by the hash generating circuit 123, based on executable area information, as described below. The buffer memory 122_2 may transmit the hash results to the attestation handler 121.

In an implementation, the hash generating circuit 123 may generate a hash result of each of the first to n-th cores 110_1 to 110_n, based on MPU information of each of the first to n-th MPUs 111_1 to 111_n, and transmit the hash result to the measurement information parser 122.

In more detail, the hash generating circuit 123 may receive executable area information of each of the first to n-th MPUs 111_1 to 111_n from the handler 122_1. The hash generating circuit 123 may read code data stored in addresses included in executable area information of each of the first to n-th MPUs 111_1 to 111_n. For example, the hash generating circuit 123 may read code data stored in addresses included in the k-th executable area information.

The hash generating circuit 123 may generate a hash result of each of the first to n-th cores 110_1 to 110_n, based on the read code data, and transmit the hash result to the measurement information parser 122. For example, the hash generating circuit 123 may generate a k-th hash result of the k-th core 110_k based on k-th code data read from addresses included in the k-th executable area information and transmit the k-th hash result to the measurement information parser 122.

In an implementation, the hash generating circuit 123 may generate a hash result of each of the first to n-th cores 110_1 to 110_n, based on code data by using a secure hash algorithm (SHA). For example, the hash generating circuit 123 may generate the k-th hash result of the k-th core 110_k based on the k-th code data by using the SHA and transmit the k-th hash result to the measurement information parser 122. However, the present disclosure is not limited thereto, and the hash generating circuit 123 may generate a hash result by using another pre-defined algorithm instead of the SHA.

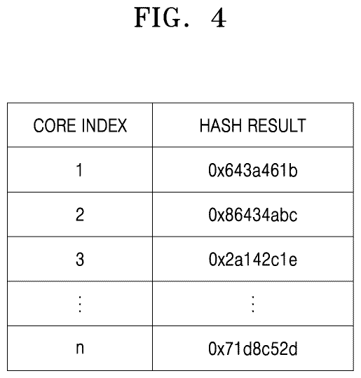

An example of hash results may be described with reference to FIG. 4.

FIG. 4 illustrates hash results generated by a storage device, according to an implementation.

Referring to FIG. 4, a table representing the index of each of the first to n-th cores 110_1 to 110_n and a hash result of a corresponding core is shown.

In the implementation of FIG. 4, the hash generating circuit 123 may generate 0x643a461b as a hash result of the first core 110_1 of which the core index is 1. The hash generating circuit 123 may generate 0x86434abc as a hash result of the second core 110_2 of which the core index is 2. The hash generating circuit 123 may generate 0x2a142c1e as a hash result of the third core 110_3 of which the core index is 3. The hash generating circuit 123 may generate 0x71d8c52d as a hash result of the n-th core 110_n of which the core index is n.

Referring back to FIG. 2, the hash generating circuit 123 may transmit the respective hash results of the first to n-th cores 110_1 to 110_n to the measurement information parser 122. The measurement information parser 122 may store the received respective hash results of the first to n-th cores 110_1 to 110_n in the buffer memory 122_2 therein and transmit the same to the attestation handler 121.

The attestation handler 121 may receive the respective hash results of the first to n-th cores 110_1 to 110_n from the measurement information parser 122 and transmit the same to the host device 200.

In an implementation, the attestation handler 121 may generate measurement information based on the respective hash results of the first to n-th cores 110_1 to 110_n upon receiving the respective hash results of the first to n-th cores 110_1 to 110_n from the measurement information parser 122. The measurement information may be information generated by converting hash results into the same format as that of endorsement information such that the host device 200 may quickly compare the endorsement information to the hash results. That is, the attestation handler 121 may convert the respective hash results of the first to n-th cores 110_1 to 110_n into the measurement information and transmit the measurement information to the host device 200. The attestation handler 121 may transmit the generated measurement information to the host device 200.

The host device 200 may receive the measurement information from the trust core 120.

In an implementation, when the measurement information is received from the storage device 100, the host device 200 may compare the measurement information to pre-stored endorsement information to determine whether falsification has occurred in the storage device 100. The endorsement information may be information used to check whether measurement information generated based on code data stored in memory areas in the storage device 100 is normal. The endorsement information may be provided by a manufacturing company of the storage device 100 and be also updated when firmware of the storage device 100 is updated.

In an implementation, the host device 200 may determine that falsification has not occurred in the storage device 100 when the endorsement information is the same as the measurement information. If code data stored in memory areas in the storage device 100 is not falsified, the endorsement information generated by the manufacturing company may be the same as measurement information generated in real-time. Therefore, if the endorsement information is the same as measurement information, the host device 200 may determine that the storage device 100 is normal.

Otherwise, if the endorsement information is different from measurement information, the host device 200 may determine that falsification has occurred in the storage device 100. If code data stored in memory areas in the storage device 100 is falsified, the endorsement information generated by the manufacturing company may be different from measurement information generated in real-time. Therefore, if the endorsement information is different from measurement information, the host device 200 may determine that the storage device 100 is abnormal.

When using the storage device 100 according to the implementation described above, if a measurement command is received from the host device 200, the storage device 100 may generate respective hash results of the first to n-th cores 110_1 to 110_n, based on MPU information, and transmit the generated hash results to the host device 200 such that it is detected whether falsification has occurred in all areas of the storage device 100, thereby improving the security performance of the storage device 100.

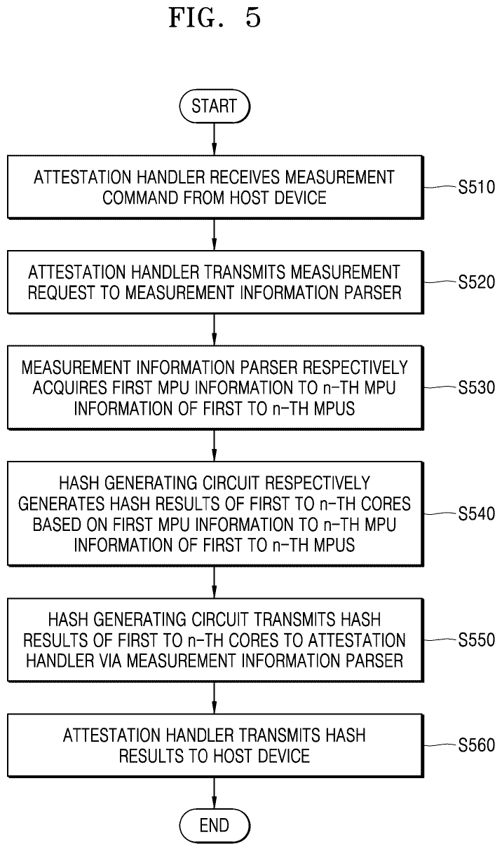

FIG. 5 is a flowchart illustrating an operating method of a storage device, according to an implementation.

Referring to FIG. 5, in operation S510, the attestation handler 121 of the storage device 100 may receive a measurement command from the host device 200. In response to the reception of the measurement command from the host device 200, the storage device 100 may perform operations, such as operations S520 to S560, to transmit, to the host device 200, hash results generated by performing an attestation operation on the first to n-th MPUs 111_1 to 111_n.

In operation S520, the attestation handler 121 of the storage device 100 may transmit a measurement request to the measurement information parser 122. In response to the reception of the measurement command from the host device 200, the attestation handler 121 may generate a measurement command for requesting the measurement information parser 122 to perform an attestation operation, and transmit the measurement request to the measurement information parser 122.

In operation S530, the measurement information parser 122 of the storage device 100 may acquire the first MPU information to the n-th MPU information of the first to n-th MPUs 111_1 to 111_n. The measurement information parser 122 may acquire the first MPU information to the n-th MPU information of the first to n-th MPUs 111_1 to 111_n via the handler 122_1. In an implementation, the handler 122_1 may read the first MPU information to the n-th MPU information of the first to n-th MPUs 111_1 to 111_n via a bus connected to each of the first to n-th MPUs 111_1 to 111_n. In another implementation, the handler 122_1 may acquire the first MPU information to the n-th MPU information of the first to n-th MPUs 111_1 to 111_n by using a request-response manner of transmitting an MPU information request to each of the first to n-th MPUs 111_1 to 111_n and receiving MPU information from each of the first to n-th MPUs 111_1 to 111_n.

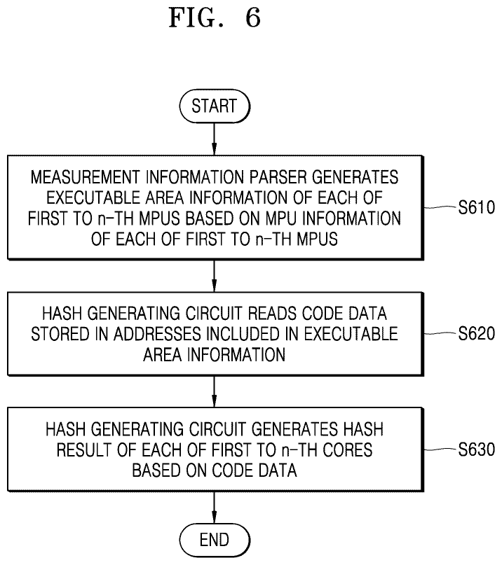

In operation S540, the hash generating circuit 123 of the storage device 100 may generate hash results of the first to n-th cores 110_1 to 110_n, based on the first MPU information to the n-th MPU information of the first to n-th MPUs 111_1 to 111_n. A further particular method, performed by the hash generating circuit 123, of generating hash results may be described with reference to FIG. 6.

FIG. 6 is a flowchart illustrating a method of generating hash results in a storage device, according to an implementation.

Referring to FIG. 6, in operation S610, the measurement information parser 122 of the storage device 100 may generate executable area information of each of the first to n-th MPUs 111_1 to 111_n, based on MPU information of each of the first to n-th MPUs 111_1 to 111_n. The measurement information parser 122 may generate the executable area information based on the addresses of memory areas managed by each of the first to n-th MPUs 111_1 to 111_n, which are included in the MPU information, and whether data stored in corresponding addresses is executable. The measurement information parser 122 may generate the executable area information by collecting addresses in which data set to be executable is stored.

In operation S620, the hash generating circuit 123 of the storage device 100 may read code data stored in the addresses included in the executable area information.

In operation S630, the hash generating circuit 123 of the storage device 100 may generate a hash result of each of the first to n-th cores 110_1 to 110_n, based on the code data. The hash generating circuit 123 may generate the hash result of each of the first to n-th cores 110_1 to 110_n by applying the SHA to the code data read in operation S620.

Referring back to FIG. 5, in operation S550, the hash generating circuit 123 of the storage device 100 may transmit the respective hash results of the first to n-th cores 110_1 to 110_n to the attestation handler 121 via the measurement information parser 122. The hash generating circuit 123 may transmit the respective hash results of the first to n-th cores 110_1 to 110_n to the measurement information parser 122. The measurement information parser 122 may store the received respective hash results of the first to n-th cores 110_1 to 110_n in the buffer memory 122_2 therein. In addition, the measurement information parser 122 may transmit the received respective hash results of the first to n-th cores 110_1 to 110_n to the attestation handler 121.

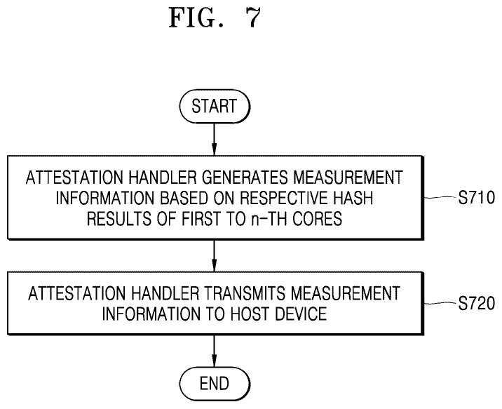

In operation S560, the attestation handler 121 of the storage device 100 may transmit the hash results to the host device 200. A further particular method, performed by the attestation handler 121, of transmitting hash results to the host device 200 is described with reference to FIG. 7.

FIG. 7 is a flowchart illustrating a method of transmitting measurement information from a storage device to a host device, according to an implementation.

Referring to FIG. 7, in operation S710, the attestation handler 121 of the storage device 100 may generate measurement information based on respective hash results of the first to n-th cores 110_1 to 110_n. The attestation handler 121 may generate the measurement information by converting the respective hash results of the first to n-th cores 110_1 to 110_n into the same format as that of endorsement information stored in the host device 200.

In operation S720, the attestation handler 121 of the storage device 100 may transmit the measurement information generated in operation S710 to the host device 200.

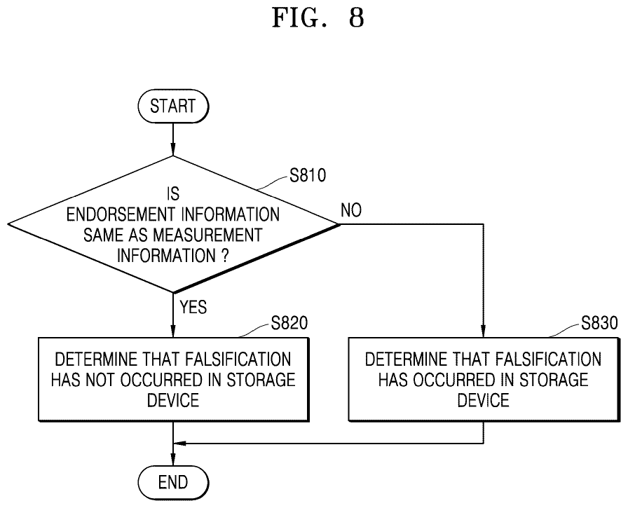

FIG. 8 is a flowchart illustrating a method, performed by a host device included in a computing device, of determining whether falsification has occurred in a storage device, according to an implementation.

Referring to FIG. 8, in response to the transmission of the measurement information from the attestation handler 121 of the storage device 100 to the host device 200 in operation S720 of FIG. 7, an operation performed by the host device 200 based on the received measurement information is shown.

In operation S810, the host device 200 may determine whether endorsement information is the same as the measurement information. That is, the host device 200 may determine whether the measurement information generated in real-time by the storage device 100 is the same as the endorsement information provided by a manufacturing company.

If it is determined that the endorsement information is the same as the measurement information, the method may proceed to operation S820 to determine that falsification has not occurred in the storage device 100. Because code data stored in executable areas of the storage device 100 is not falsified such that measurement information generated based on the code data is the same as endorsement information generated based on code data stored by a manufacturing company, the host device 200 may determine that falsification has not occurred in the storage device 100.

Otherwise, if it is determined that the endorsement information is different from the measurement information, the method may proceed to operation S830 to determine that falsification has occurred in the storage device 100. Because the code data stored in the executable areas of the storage device 100 is falsified such that measurement information generated based on the code data is different from the endorsement information generated based on the code data stored by the manufacturing company, the host device 200 may determine that falsification has occurred in the storage device 100.

When using the operating method of the storage device 100 according to the implementation described above, measurement information generated based on MPU information may be used to detect whether falsification has occurred in the storage device 100, thereby improving the security performance of the storage device 100.

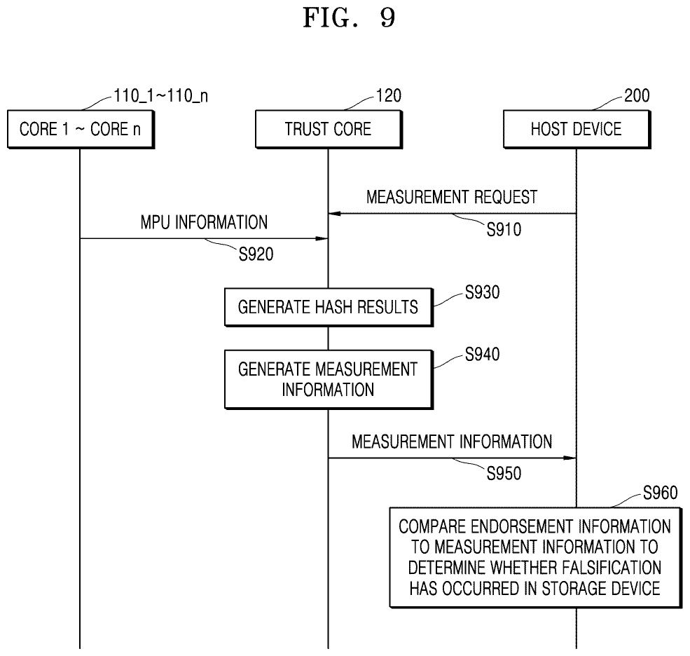

FIG. 9 is a signaling diagram illustrating an operating method of a computing device, according to an implementation.

Referring to FIG. 9, in operation S910, the host device 200 may transmit a measurement command to the trust core 120 of the storage device 100. The measurement command may be a command for requesting the storage device 100 to generate measurement information and transmit the measurement information to the host device 200.

In operation S920, the trust core 120 may read the first MPU information to the n-th MPU information from the first to n-th cores 110_1 to 110_n of the storage device 100, in response to reception of the measurement command from the host device 200. MPU information may be information indicating the addresses of memory areas managed by an MPU and whether data stored in corresponding addresses is executable.

In operation S930, the trust core 120 may generate hash results based on the first MPU information to the n-th MPU information read in operation S920. The trust core 120 may read code data stored in executable areas, based on the first MPU information to the n-th MPU information, and generate hash results by applying the SHA to the code data.

In operation S940, the trust core 120 may generate measurement information based on the hash results generated in operation S930. The measurement information may be information generated by converting the hash results into the same format as that of endorsement information.

In operation S950, the trust core 120 may transmit the measurement information generated in operation S940 to the host device 200.

In operation S960, the host device 200 may compare the endorsement information to the measurement information to determine whether falsification has occurred in the storage device 100. The host device 200 may compare the endorsement information stored therein to measurement information generated in real-time by the storage device 100, to determine whether falsification has occurred in the storage device 100.

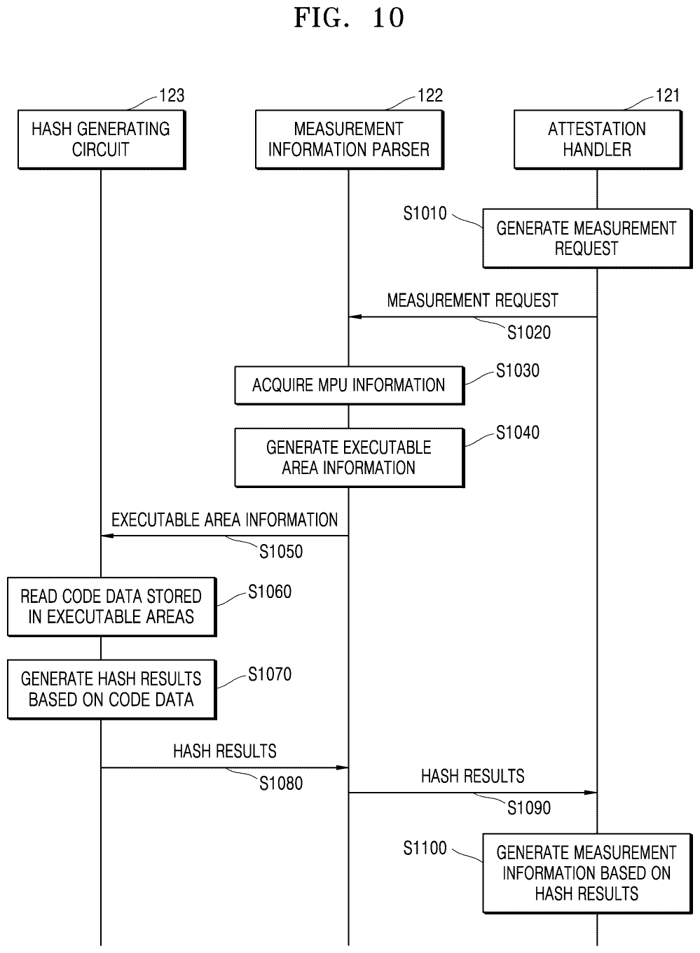

FIG. 10 is a signaling diagram illustrating an operating method of components included in a trust core of a storage device, according to an implementation.

Referring to FIG. 10, in operation S1010, the attestation handler 121 may generate a measurement request. The attestation handler 121 may generate the measurement request upon receiving a measurement command from the host device 200.

In operation S1020, the attestation handler 121 may transmit the measurement request generated in operation S1010 to the measurement information parser 122.

In operation S1030, the measurement information parser 122 may acquire the first MPU information to the n-th MPU information of the first to n-th MPUs 111_1 to 111_n. Upon receiving the measurement request, the measurement information parser 122 may access the first to n-th MPUs 111_1 to 111_n and read the first MPU information to the n-th MPU information of the first to n-th MPUs 111_1 to 111_n.

In operation S1040, the measurement information parser 122 may generate executable area information of the first to n-th MPUs 111_1 to 111_n, based on the first MPU information to the n-th MPU information of the first to n-th MPUs 111_1 to 111_n. The measurement information parser 122 may generate executable area information including addresses set to be executable among the addresses of the memory areas included in MPU information.

In operation S1050, the measurement information parser 122 may transmit the executable area information generated in operation S1040 to the hash generating circuit 123.

In operation S1060, the hash generating circuit 123 may read code data stored in executable areas. Upon receiving the executable area information, the hash generating circuit 123 may access memory areas corresponding to addresses included in the executable area information and read the code data.

In operation S1070, the hash generating circuit 123 may generate hash results based on the code data. The hash generating circuit 123 may generate the hash results by applying a hash algorithm (e.g., the SHA) to the code data.

In operation S1080, the hash generating circuit 123 may transmit the hash results generated in operation S1070 to the measurement information parser 122.

In operation S1090, the measurement information parser 122 may transmit, to the attestation handler 121, the hash results received from the hash generating circuit 123.

In operation S1100, the attestation handler 121 may generate measurement information based on the hash results. Upon receiving the hash results, the attestation handler 121 may generate the measurement information by converting the hash results into the same format as that of the endorsement information.

According to an aspect of the present disclosure, wherein the MPU information of each of the plurality of MPUs comprises addresses of memory areas managed by a respective MPU of the plurality of MPUs and information indicative of data stored in corresponding addresses being executable, and wherein the executable area information of each of the plurality of MPUs comprises addresses that store executable data of the addresses of the memory areas managed by a respective MPU of the plurality of MPUs.

According to an aspect of the present disclosure, wherein the handler is configured to transmit an MPU information request to each of the plurality of MPUs and receive the MPU information from each of the plurality of MPUs.

According to an aspect of the present disclosure, wherein the hash generating circuit is configured to generate, based on the code data, the hash result of each of the plurality of cores by using a secure hash algorithm.

According to an aspect of the present disclosure, wherein the attestation handler is configured to, in response to receiving the hash result of each of the plurality of cores from the measurement information parser, generate the measurement information based on the hash result of each of the plurality of cores and transmit the measurement information to the host device.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A storage device comprising:
a plurality of cores respectively comprising a plurality of memory protection units (MPUs); and
a trust core configured to:
in response to receiving a measurement command from a host device, acquire MPU information of each of the plurality of MPUs,
generate, based on the MPU information of each of the plurality of MPUs, a hash result of each of the plurality of cores, and
transmit the hash result of each of the plurality of cores to the host device.

2. The storage device of claim 1, wherein the trust core comprises:
an attestation handler configured to generate a measurement request in response to receiving the measurement command from the host device;
a measurement information parser configured to acquire the MPU information of each of the plurality of MPUs in response to receiving the measurement request from the attestation handler; and
a hash generating circuit configured to generate, based on the MPU information of each of the plurality of MPUs, the hash result of each of the plurality of cores, and transmit the hash result of each of the plurality of cores to the measurement information parser.

3. The storage device of claim 2, wherein the measurement information parser comprises:
a handler configured to read the MPU information from each of the plurality of MPUs and generate, based on the MPU information of each of the plurality of MPUs, executable area information of each of the plurality of MPUs; and
a buffer memory configured to store the hash result of each of the plurality of cores that are received from the hash generating circuit.

4. The storage device of claim 3, wherein the MPU information of each of the plurality of MPUs comprises addresses of memory areas managed by a respective MPU of the plurality of MPUs and information indicative of data stored in corresponding addresses being executable, and
wherein the executable area information of each of the plurality of MPUs comprises addresses that store executable data of the addresses of the memory areas managed by a respective MPU of the plurality of MPUs.

5. The storage device of claim 3, wherein the handler is configured to transmit an MPU information request to each of the plurality of MPUs and receive the MPU information from each of the plurality of MPUs.

6. The storage device of claim 3, wherein the hash generating circuit is configured to:
in response to receiving the executable area information of each of the plurality of MPUs from the handler, read code data stored in addresses included in the executable area information;
generate, based on the code data, the hash result of each of the plurality of cores; and
transmit the hash result of each of the plurality of cores to the measurement information parser.

7. The storage device of claim 6, wherein the hash generating circuit is configured to generate, based on the code data, the hash result of each of the plurality of cores by using a secure hash algorithm.

8. The storage device of claim 2, wherein the attestation handler is configured to, in response to receiving the hash result of each of the plurality of cores from the measurement information parser, generate measurement information based on the hash result of each of the plurality of cores and transmit the measurement information to the host device.

9. An operating method of a storage device, the storage device comprising a plurality of cores respectively including a plurality of memory protection units (MPUs), the method comprising:
receiving, using an attestation handler of a trust core in the storage device, a measurement command from a host device;
transmitting, using the attestation handler, a measurement request to a measurement information parser of the trust core;
acquiring, using the measurement information parser, MPU information of each of the plurality of MPUs;
generating, using a hash generating circuit of the trust core, a hash result of each of the plurality of cores based on the MPU information of each of the plurality of MPUs;
transmitting, using the hash generating circuit, the hash result of each of the plurality of cores to the attestation handler via the measurement information parser; and
transmitting, using the attestation handler, the hash result of each of the plurality of cores to the host device.

10. The method of claim 9, comprising generating executable area information of each of the plurality of MPUs based on the MPU information of each of the plurality of MPUs.

11. The method of claim 10, wherein the MPU information of each of the plurality of MPUs comprises addresses of memory areas managed by a respective MPU of the plurality of MPUs and information indicative of data stored in corresponding addresses being executable, and
wherein the executable area information of each of the plurality of MPUs comprises addresses that stores executable data of the addresses of the memory areas managed by a respective MPU of the plurality of MPUs.

12. The method of claim 10, wherein generating the hash result of each of the plurality of cores comprises:
reading, using the hash generating circuit, code data stored in addresses included in the executable area information; and
generating, using the hash generating circuit, the hash result of each of the plurality of cores based on the code data.

13. The method of claim 12, wherein generating the hash result of each of the plurality of cores based on the code data comprises generating, based on the code data, the hash result of each of the plurality of cores by using a secure hash algorithm (SHA).

14. The method of claim 9, wherein transmitting, using the attestation handler, the hash result of each of the plurality of cores to the host device comprises:
generating, using the attestation handler, measurement information based on the hash result of each of the plurality of cores; and
transmitting, using the attestation handler, the measurement information to the host device.

15. A computing device comprising:
a host device configured to transmit a measurement command; and
a storage device,
wherein the storage device comprises:
a plurality of cores respectively comprising a plurality of memory protection units (MPUs); and
a trust core, wherein the trust core is configured to, in response to receiving the measurement command from the host device, acquire MPU information of each of the plurality of MPUs; generate, based on the MPU information of each of the plurality of MPUs, a hash result of each of the plurality of cores; generate measurement information based on the hash result; and transmit the measurement information to the host device.

16. The computing device of claim 15, wherein the trust core comprises:
an attestation handler configured to generate a measurement request in response to receiving the measurement command from the host device;
a measurement information parser configured to, in response to receiving the measurement request from the attestation handler, acquire the MPU information of each of the plurality of MPUs; and
a hash generating circuit configured to generate, based on the MPU information of each of the plurality of MPUs, the hash result of each of the plurality of cores, and transmit the hash result of each of the plurality of cores to the measurement information parser.

17. The computing device of claim 16, wherein the measurement information parser comprises:
a handler configured to read the MPU information from each of the plurality of MPUs and generate, based on the MPU information of each of the plurality of MPUs, executable area information of each of the plurality of MPUs; and
a buffer memory configured to store the hash result of each of the plurality of cores that are received from the hash generating circuit.

18. The computing device of claim 17, wherein the hash generating circuit is configured to, in response to receiving the executable area information of each of the plurality of MPUs from the handler, read code data stored in addresses included in the executable area information; generate, based on the code data, the hash result of each of the plurality of cores; and transmit the hash result of each of the plurality of cores to the measurement information parser.

19. The computing device of claim 15, wherein the host device is configured to, in response to receiving the measurement information from the storage device, compare pre-stored endorsement information to the measurement information to determine whether falsification has occurred in the storage device.

20. The computing device of claim 19, wherein the host device is configured to:
in response to the endorsement information being a same as the measurement information, determine that falsification has not occurred in the storage device; and
in response to the endorsement information being different from the measurement information, determine that falsification has occurred in the storage device.
